(19) United States
(12) Patent Application Publication
(10) Pub. No.: US 2005/0212315 A1
(43) Pub. Date: Sep. 29, 2005

(54) Anchor shovel

(76) Inventor: Daniel Jean, Jonquiere (CA)

Correspondence Address: INVENTARIUM, suite 1607, 4050 rosemont blvd, Montreal, H1X 1M4, CA

(21) Appl. No.: 10/810,201

(22) Filed: Mar. 26, 2004

(51) Int. Cl. A01B 1/22

(52) U.S. Cl. 294/51

(57) ABSTRACT

An anchor shovel has an articulated shoveling part which is orientable by way of removable clips which allow for detachment of the shovel part from the handle part. Once detached, the shovel part can be reattached in its new configuration in relation to the handle which changes its function which is either to be a shovel, an anchor or compact and folded for transport.

### BACKGROUND OF THE INVENTION

1. Field of the Invention

This invention relates generally to shovels and spades and more particularly to a spade that can be articulated in such a way as to serve as ground anchor.

2. Background

Shovels have been adapted and modified to make them more compact for ease in transport as well as made more versatile so that they can serve more than one purpose, to the point of becoming several tools, depending upon how they are modified and used.

The prior art reveals several different ways in which a basic shovel can be modified to accomplish different tasks. A number of early patents are concerned with the digging of trenches and combine a shovel with a hoe, while other more recent patents cater to the needs of campers and trekkers who require a combination of tools neatly packed into a compact device. It appears that special features, functions and modifications are required to achieve a specific function and execute it well.

The prior art does not reveal a shovel that could perform the functions of the herein described invention i.e. Serve as an anchor planted into the ground.

### SUMMARY OF THE INVENTION

It is a first object of this invention is to provide for a shovel which can be made very compact for transport and carrying purposes.

It is a second object of this invention to provide a shovel acting as an anchor.

It is a third object of this invention to optionally offer a handle which is telescopic.

It is a final object of this invention to provide for a shovel that can quickly change from shovel mode to anchor mode and compact mode.

In order to do so, the shovel has an articulated shoveling part which is orientable by way of removable clips which allow for detachment of the shovel part from the handle part. Once detached, the shovel part can be reattached in its new configuration in relation to the handle which changes its function which is either to be a shovel, an anchor or compact and folded for transport.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

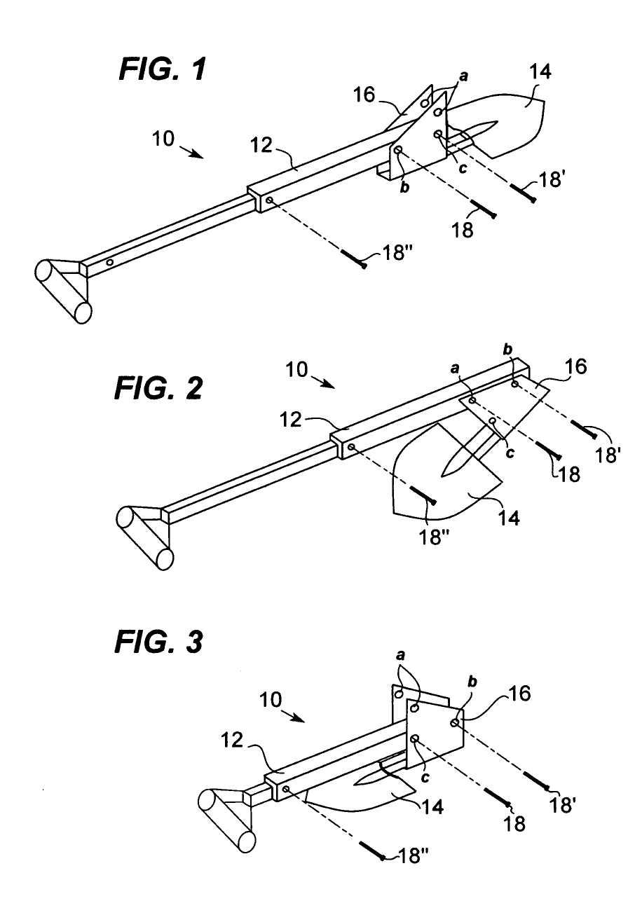

FIG. 1 Perspective view of the shovel in shovel mode.

FIG. 2 Perspective view of the shovel in anchor mode.

FIG. 3 Perspective view of the shovel in transport mode.

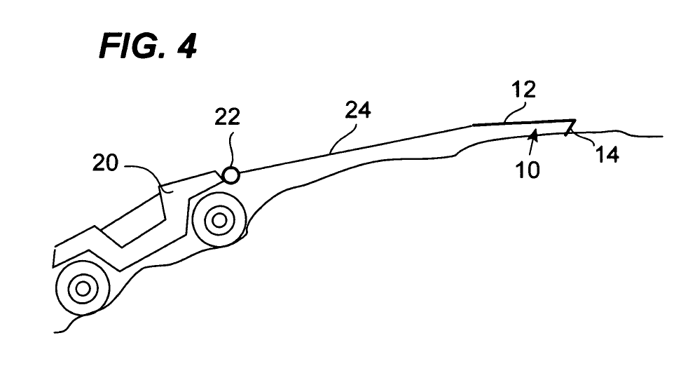

FIG. 4 Side elevation of the shovel in a scenario of use as an anchor.

### DETAILED DESCRIPTION OF THE PREFERRED EMBODIMENT

An anchor shovel (10) has a handle (12), which can be of fixed length but could also be telescopically variable in length, and a shovel part (14). The shovel part (14) is permanently connected, to a connecting element (16) which is itself releasably connectable to the handle (12).

The type of connection selected gives a mode of operation. There are three modes of operations:

The first mode, being featured in FIG. 1, is the shovel mode which allows the anchor shovel (10) to be used like a regular shovel.

The second mode, as featured in FIG. 2, illustrates how it is configured to act as an anchor.

The third mode, as seen in FIG. 3, shows how the anchor shovel (10) can be made more compact for transport, storage or when not in use, as the shovel part (14) is folded and parallel to the handle (12).

To change from one mode to another, a set of two clips (18 and 18′) are pulled out from holes, identified by the letters a, b and c, doing so releases the shovel part (14) and the connecting element (16) from the handle (12) and allows for reorientation. For example, in FIG. 1, the clips (18 and 18′) are inserted into holes b and c, which allows the connecting element (16) to be reoriented in such a way as to allow the shovel part (14) to be used as a regular shovel.

In FIG. 2, to change into anchor mode, the clips (18 and 18′) are removed from holes b and c, the shovel part (14) is turned around half a turn and reoriented so that the clips (18 and 18′) are inserted into holes a and b.

In FIG. 3, in order to change from anchor mode into transport mode, holes b and c are used once again but only clip (18), which was in a, needs to be removed in order to be inserted into c. In this way, the tip of the shovel part (14) is pointed toward the opposite direction than in FIG. 1 and lays generally parallel to the handle (12). Also, a third clip (18″) can be used to lock the handle (12) into either a retracted configuration as in FIG. 3 or a protracted configuration, as seen in FIGS. 1 and 2. The drawings illustrating but one of several variations of handles, it should be obvious that a tubular shaped handle (12) could be used and that a tightening ring could be used to adjust the telescopic handle (12) lengthwise or that a fixed length handle can also be used without departing from the scope of the invention.

In the event that a vehicle (20) is stuck in a ditch as FIG. 4 illustrates, providing that it is equipped with a hoist (22), the anchor shovel (10) is anchored into the ground and a cable (24) is attached onto the handle (12). When the hoist (22) is activated, the tension in the cable (24) further engages the shovel part (14) into the ground to increase its anchoring ability. In most circumstances, enough drag is generated by the shovel part (14) to pull an ATV (20) out of a ditch. The hoist (22) need not be necessarily on the vehicle (20) as it could be temporarily attached to the handle (12) or temporarily attached to the vehicle (20).

1. An anchor shovel for use as an anchor comprising:
a handle, a shovel part, a connecting element to fixedly connect said shovel part and releasably connect said handle;
a plurality of clips;
said clips being releasably engaged to said connecting element and to said handle;
said connecting element having a plurality of holes through which pass said clips;
said connecting element so configured as to be orientable in relation to said handle so as to allow said shovel part to be oriented in a variety of ways in relation to said handle by using combinations of said clips engaging through specific holes combinations of said connecting element and into said handle with each specific combination providing a specific mode;
said connecting element in cooperation with said handle and said shovel part offering the following modes of of operation:
a) a shovel mode which allows said anchor shovel to be used like a regular shovel;
b) an anchor mode which allows said anchor shovel to be used like an anchor;
c) a folded mode which allows said anchor shovel to be more compact such as for transport, storage, or when not in use;

2. An anchor shovel for use as an anchor having the following method of use:
said anchor shovel is configured in anchor mode and anchored into the ground;
a cable from a hoist on a vehicle is attached onto said anchor shovel's handle;
when said hoist is being activated, tension in said cable further engages shovel part of said anchor shovel into the ground to increase said anchor shovel's anchoring ability.

3. An anchor shovel for use as an anchor as in claim 1 wherein
said handle has a fixed length.

3. An anchor shovel for use as an anchor as in claim 1 wherein:
said handle is telescopically variable in length.
